(19) United States
(12) Patent Application Publication
(10) Pub. No.: US 2017/0354251 A1
(43) Pub. Date: Dec. 14, 2017

(54) VIBRATION DAMPING SHELF

(71) Applicant: KYB CORPORATION, Minato-ku, Tokyo (JP)

(72) Inventors: Shinichi SEKINE, Minato-ku, Tokyo (JP); Yasushi SAITO, Hanishina-gun, Nagano (JP); Masanori OGURA, Minato-ku, Tokyo (JP); Teruhiko INOUE, Minato-ku, Tokyo (JP); Kenji ISSHIN, Minato-ku, Tokyo (JP); Keita ABE, Minato-ku, Tokyo (JP)

(73) Assignee: KYB CORPORATION, Minato-ku, Tokyo (JP)

(21) Appl. No.: 15/538,433

(22) PCT Filed: Dec. 14, 2015
(86) PCT No.: PCT/JP2015/084964

§ 371 Date: Jun. 21, 2017

(30) Foreign Application Priority Data
Dec. 22, 2014 (JP) 2014-258607

(51) Int. Cl. A47B 96/02; F16F 9/48; F16F 9/32; F16F 9/44; A47B 97/00

(52) U.S. Cl. CPC A47B 96/02; F16F 9/3242; F16F 9/44; F16F 9/48; A47B 97/00

(57) ABSTRACT

Providing a vibration damping shelf which can suppress fall of articles placed on a shelf member while suppressing shake of other articles or the like. The vibration damping shelf includes a damper and shelf plates. The damper has two ends mounted, on a top surface of a piece of furniture and a ceiling spaced from each other in an up-down direction. The shelf plates are held on the damper.

### TECHNICAL FIELD

The present invention relates to a vibration damping shelf.

### BACKGROUND ART

Patent Document 1 discloses a conventional vibration damping shelf. The vibration damping shelf includes a shelf body and a pair of dampers. The shelf body has four support pillars and a plurality of rectangular shelf plates. Four corners of each shelf plate are respectively fixed to the four support pillars, and the shelf plates are disposed so as to be vertically spaced from each other. The paired dampers are each mounted between two support pillars arranged in a short side direction of the shelf plate at both ends of the shelf plate in a long side direction. The paired dampers are disposed to be inclined in opposite directions so that the dampers intersect with each other. As a result, the vibration damping shelf can suppress distortion of the shelf body due to quakes of earthquake or the like. Thus, the vibration damping shelf can suppress shake of the shelf body and accordingly suppress fall of articles placed on the shelf plate and overturn of the shelf body.

### PRIOR ART DOCUMENT

### Patent Documents

Patent Document 1: Japanese Unexamined Patent Application Publication No. JP 2013-42774

### SUMMARY OF THE INVENTION

### Problem to be Overcome by the Invention

However, the purpose of the vibration damping shelf of Patent Document 1 is only suppressing shake of the shelf body and suppressing fall of articles placed on the shelf plate and overturn of the shelf body. Thus, the vibration damping shelf cannot suppress quake of a room and the like in which the vibration damping shelf is installed, or suppress shake of other articles such as furniture by mounting the vibration damping shelf to other articles.

The present invention was made in view of the above-described circumstances in the conventional art and has an object to provide a vibration damping shelf which can suppress fall of articles placed on a shelf member while suppressing shake of other articles or the like.

### Means for Overcoming the Problem

A vibration damping shelf of the present invention includes a damper and a shelf member. The damper has two ends mounted on respective positions spaced from each other in an up-down direction. The shelf member is held on the damper.

The shelf member may have a right end and a left end both of which are respectively held on a pair of the dampers. Furthermore, the paired dampers may have respective axis lines extending from upper ends to lower ends of the dampers. The axis lines may be inclined with the ends of the dampers being mounted on the positions spaced from each other in the up-down direction. Still furthermore, the axis lines of the paired dampers may have respective directions of inclination opposed to each other as the dampers are viewed sideways

The ends of the damper/dampers may respectively be mounted on an installation surface and a ceiling, or the installation surface and a wall surface extending vertically from the installation surface, or the wall surface and the ceiling, or a top surface of an article installed on the installation surface and the ceiling, or the top surface of the article and the wall surface.

A compression coil spring may further be mounted between counterpart members identical with those on which upper and lower ends of the damper are respectively mounted.

The damper or each of the dampers may include a cylinder, a piston, a rod guide and a rod, and the shelf member may be held on the cylinder. The cylinder is bottomed and cylindrical in shape. The piston is slidably inserted into the cylinder. The rod guide closes an opening of the cylinder. The rod has a proximal end connected to the piston and a distal end side which is inserted through the rod guide and protrudes out of the cylinder.

The article includes furniture, a bunk bed having a plurality of beds connected to each other in the up-down direction, large sized televisions, refrigerators, book shelves, showcases and server racks, all of which have a possibility of being overturned by quakes of earthquake or the like. The installation surface includes foundation surfaces which are located outside buildings and on which articles are installed, as well as floor surfaces located inside buildings.

### BRIEF DESCRIPTION OF THE DRAWINGS

FIG. 1 is a side elevation of the vibration damping shelf of a first embodiment, illustrating both ends of the damper respectively mounted on the top surface of the furniture and the ceiling;

FIG. 2 is a perspective view of the vibration damping shelf of the first embodiment, illustrating both ends of each damper respectively mounted on the top surface of the furniture and the ceiling;

FIG. 3 is a perspective view of the vibration damping shelf of a second embodiment, illustrating both ends of each damper respectively mounted on the top surface of the furniture and the ceiling;

FIG. 4 is a side elevation of the vibration damping shelf of a third embodiment, illustrating both ends of the damper respectively mounted on the ceiling and a floor surface;

FIG. 5 is a perspective view of the vibration damping shelf of a fourth embodiment, illustrating both ends of the damper respectively mounted on the ceiling and the floor surface; and

FIG. 6 is a perspective view of the vibration damping shelf of a fifth embodiment, illustrating both ends of each damper respectively mounted on the top surface of the furniture and the ceiling.

### BEST MODE FOR CARRYING OUT THE INVENTION

First to fifth embodiments of the vibration damping shelf of the present invention will be described with reference to the drawings.

### First Embodiment

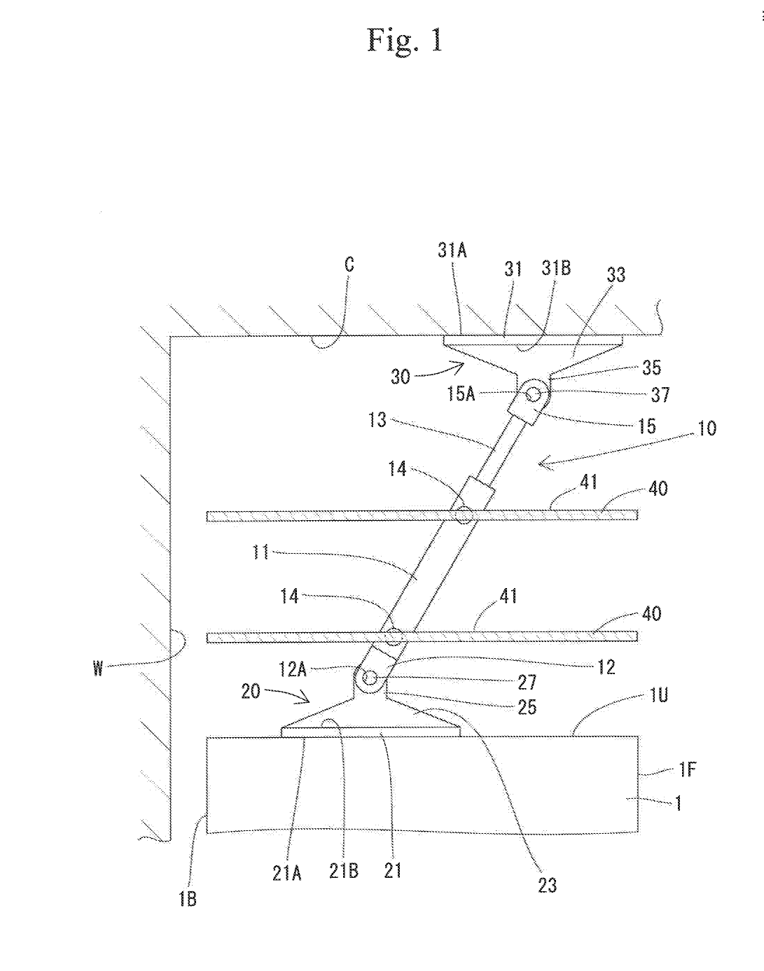

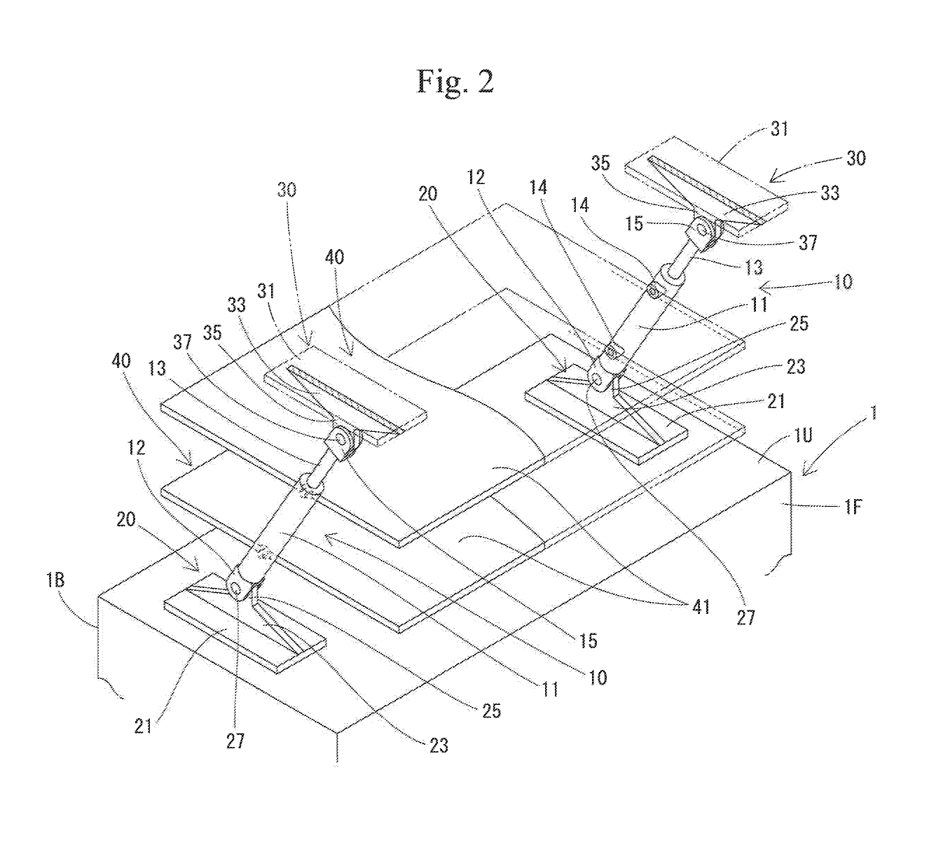

Referring to FIGS. 1 and 2, the vibration damping shelf of the first embodiment includes a pair of dampers 10 and two shelf plates 40 each serving as a shelf member. Each damper 10 has two ends respectively mounted on a top surface 1U of a piece of furniture 1 and a ceiling C. In other words, both ends of each damper 10 are respectively mounted on positions spaced from each other in an up-down direction. The furniture 1 is installed on a floor surface (not illustrated) while a rear surface 1B thereof is opposed to a wall surface W vertically extending from the floor surface. The furniture 1 is formed into a cuboid shape and has a door, drawers (neither illustrated), and the like in a front surface 1F, so that clothes, accessories, and the like can be housed in the furniture 1. The furniture 1 has a rectangle-shaped horizontal section long in a right-left direction (a depthwise direction in FIG. 1). When the vibration damping shelf is not mounted on the furniture 1, the furniture 1 would possibly be tilted frontward (rightward in FIG. 1) by quakes of earthquake or the like thereby to be overturned.

Each damper 10 has a cylinder 11, a rod guide (not illustrated), a piston (not illustrated), a rod 13, a first base 20, and a second base 30. The cylinder 11 is bottomed and has a cylindrical shape. The cylinder 11 is provided with two holding parts 14 respectively formed on two locations of an outer peripheral surface thereof to hold shelf plates 40. The holding parts 14 are located on a straight line parallel to an axis line of the cylinder with a distance therebetween. The holding parts 14 are configured to hold the shelf plates 40 so that upper surfaces of the shelf plates 40 are horizontally spread, when both ends of each damper 10 are respectively mounted on the top surface 1U of the furniture 1 and the ceiling C with the axis line of each damper 10 being inclined at a predetermined angle.

The rod guide closes an opening of the cylinder 11. The piston is slidably inserted into the cylinder 11. The rod 13 has a proximal end connected to the piston and a distal end side that is inserted through the rod guide and protrudes out of the cylinder 11. Operating oil and a compression gas are enclosed in the cylinder 11. When each damper 10 is contracted so that the compression gas enclosed in the cylinder 11 is compressed, an expansion force of the compression gas is imparted to the damper 10 in a direction such that the length of the damper 10 is increased.

The first base 20 has a first base plate 21 and a first connecting part 23. The first base plate 21 has a flat plate shape and includes a first abutment surface 21A brought into face-to-face contact with the top surface 1U of the furniture 1. The first abutment surface 21A is rectangular in shape. The first connecting part 23 has a flat plate shape and upwardly protrudes continuously from a surface 21B of the first base plate 21 (a surface located at the side opposed to the first abutment surface 21A) with the first base 20 having been mounted on the top surface 1U of the furniture 1. In more detail, the first connecting part 23 longitudinally extends in a middle part of the first base plate 21 with respect to the short side direction and, with the first base 20 having been mounted on the top surface 1U of the furniture 1, the first connecting part 23 has upper surfaces which are inclined so as to ascend from both longitudinal ends toward a middle part thereof and has a first convex part 25 upwardly protruding in the longitudinal middle part of the first connecting part 23. The first convex part 25 has a first shaft 27 which is columnar in shape and extends from both side surfaces of the first convex part 25 on an identical straight line perpendicular to the side surfaces.

The cylinder 11 has a proximal end further having a pair of flat plate-shaped cylinder-side connecting parts 12 formed to hold the first convex part 25 of the first base 20 therebetween. Each cylinder-side connecting part 12 has a distal end with a semicircular outer edge. Each cylinder-side connecting part 12 is provided with a through hole 12A formed on an identical straight line perpendicular to an axis line of the cylinder 11. Both ends of the first shaft 27 extending from both side surfaces of the first convex part 25 are respectively inserted into the through holes 12A provided in the cylinder-side connecting parts 12 in a retained state, so that the cylinder 11 is connected to the first base 20 so as to be rotatable about the first shaft 27.

The second base 30 has a second base plate 31 and a second connecting part 33. The second base plate 31 has a flat plate shape and includes a second abutment surface 31A brought into face-to-face contact with the ceiling C. The second abutment surface 31A is rectangular in shape. The second connecting part 33 has a flat plate shape and downwardly protrudes continuously from a surface 31B of the second base plate 31 (a surface located at the side opposed to the second abutment surface 31A) with the second base 30 having been mounted on the ceiling C. In more detail, the second connecting part 33 longitudinally extends in a middle part of the second base plate 31 with respect to the short side direction and, with the second base 30 having been mounted on the ceiling C, the second connecting part 33 has lower surfaces which are inclined so as to descend from both longitudinal ends toward a middle part thereof and has a second convex part 35 downwardly protruding in the longitudinal middle part of the second connecting part 33. The second convex part 35 has a second shaft 37 which is columnar in shape and extends from both side surfaces of the second convex part 35 on an identical straight line perpendicular to the side surfaces.

The rod 13 has a distal end further having a pair of flat plate-shaped rod-side connecting parts 15 formed to hold the second convex part 35 of the second base 30 therebetween. Each rod-side connecting part 15 has a distal end with a semicircular outer edge. Each rod-side connecting part 15 is provided with a through hole 15A formed on an identical straight line perpendicular to an axis line of the rod 13. Both ends of the second shaft 37 extending from both side surfaces of the second convex part 35 are respectively inserted into through holes 15A provided in the rod-side connecting parts 15 in a retained state, so that the rod 13 is connected to the second base 30 so as to be rotatable about the second shaft 37.

Each damper 10 is a compression damper in which a damping force generated during an extending operation is smaller than a damping force generated during a contracting operation. The extending operation of the damper 10 refers to an operation which increases a protrusion length of the rod 13 out of the cylinder 11 and an entire length of the damper 10. On the other hand, the contracting operation of the damper 10 refers to an operation which reduces the protrusion length of the rod 13 out of the cylinder 11 and the entire length of the damper 10.

A mechanism that each damper 10 generates a damping force will be described. Since the mechanism has a known structure, illustration is eliminated. The cylinder 11 has an interior divided by the piston into a rod side pressure chamber in which the proximal end of the rod 13 is housed and a counter-rod side pressure chamber. The piston is formed with an orifice which may be a throttle valve communicating between both pressure chambers. The orifice functions as a damping force generator which applies resistance to a flow of the operating oil between the rod side pressure chamber and the counter-rod side pressure chamber with the extending/contracting operation of each damper 10. Furthermore, the piston is formed with a communication path communicating via a check valve with both pressure chambers. The check valve allows the operating oil to flow from the rod side pressure chamber to the counter-rod side pressure chamber and blocks reverse flow of the operating oil. Accordingly, the damper 10 has two flow paths of the operating oil from the rod side pressure chamber to the counter-rod side pressure chamber during the extending operation, that is, one flow path including the orifice and the other flow path including the communication path. On the other hand, the damper 10 has only one flow path of the operating oil from the counter-rod side pressure chamber to the rod side pressure chamber through the orifice during the contracting operation. Accordingly, the damping force generated by the damper 10 during the extending operation is smaller than the damping force generated by the damper 10 during the contracting operation.

Each shelf plate 40 is flat-plate-shaped and has a rectangular shape long in the right-left direction. Each shelf plate 40 includes short sides which respectively serve as right and left ends thereof and are each held on the holding part 14 provided on the cylinder 11 of the damper 10. Each first base 20 is mounted on the top surface 1U of the furniture 1 and each second base 30 is mounted on the ceiling C so that the axis line of each damper 10 is inclined at a predetermined angle. In other words, each first base 20 is mounted on the top surface 1U at the rear surface 1B side of the furniture 1, and each second base 30 is mounted on the ceiling C at the front surface 1F side of the furniture 1 as compared with each first base 20. As a result, the axis lines of the respective dampers 10 extending from the upper ends to the lower ends of the dampers 10 are inclined downwardly in the direction of the rear surface 1B of the furniture 1 in parallel to each other, so that the shelf plates 40 are held with a space therebetween in the up-down direction so that the upper surfaces 41 are spread in the horizontal direction.

In the vibration damping shelf, the first abutment surfaces 21A of the respective first bases 20 are caused to be brought into face-to-face contact with the top surface 1U of the furniture 1 thereby to be placed thereon. Then, the second abutment surfaces 31A of the respective second bases 30 are caused to be brought into face-to-face contact with the ceiling C while the dampers 10 having been extended to the maximum by an expansion force of the compression gas enclosed in the respective cylinders 11 are being contracted, so that the vibration damping shelf is mounted on the top surface 1U of the furniture 1 and the ceiling C. Thus, both ends of each damper 10 of the vibration damping shelf can respectively be mounted on the top surface 1U of the furniture 1 and the ceiling C. Upon occurrence of quakes of earthquake or the like, the dampers 10 of the vibration damping shelf are contracted with the result that the quakes can be damped by the damping force of the dampers 10. In other words, the vibration damping shelf can suppress shake of the shelf plates 40 each having the right and left ends held by the dampers 10 and accordingly suppress fall of articles placed on the shelf plates 40. In the vibration damping shelf, the shelf plates 40 are held on the holding parts 14 provided on the cylinders 11. When quakes of earthquake or the like extend/contract the dampers 10, the rods 13 move forward and backward relative to the respective cylinders 11. Therefore, displacement of the cylinders 11 is small, and accordingly fluctuation of heightwise positions of the respective shelf plates 40 can be reduced. As a result, the vibration damping shelf can suppress fall of the articles placed on the shelf plates 40 due to quakes of earthquake or the like.

Furthermore, the furniture 1 on which the first bases 20 of the dampers 10 are mounted is subjected to a force from quakes of earthquake or the like. The force can be damped by the damping force of the dampers 10 with the result that shake of the furniture 1 can be suppressed. In other words, the vibration damping shelf can damp the force to tilt the furniture 1 due to quakes of earthquake or the like thereby to prevent the furniture 1 from overturn.

Accordingly, the vibration damping shelf of the first embodiment can prevent the furniture 1 from overturn by suppressing shake of the furniture 1, while suppressing fall of the articles placed on the shelf plates 40.

### Second Embodiment

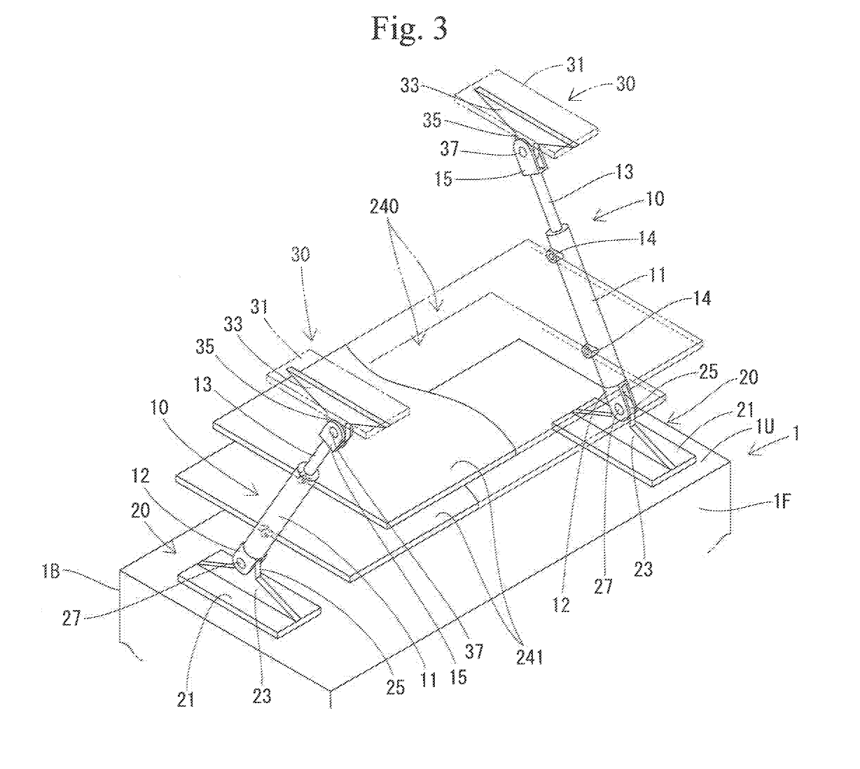

The vibration damping shelf of a second embodiment, as illustrated in FIG. 3, differs from that of the first embodiment in that inclination directions of the axis lines of the respective dampers 10 inclined downwardly and extending from the upper ends to the lower ends are opposed to each other as viewed sideways. In the second embodiment, the identical or similar parts are labeled by the same reference symbols as those in the first embodiment and detailed description of such parts will be eliminated.

The vibration damping shelf includes the paired dampers 10 and two shelf plates 240 serving as the shelf members. Each shelf plate 240 has short sides which serve as the right and left ends thereof and are each held on the holding part 14 provided on the cylinder 11 of the damper 10. The shelf plates 240 are held with a space therebetween in the up-down direction so that the upper surfaces 241 thereof are spread in the horizontal direction. The first bases 20 of the dampers 10 are mounted on the top surface 1U of the furniture 1 and the second bases 30 of the dampers 10 are mounted on the ceiling c so that the axis lines of the respective dampers 10 extending from the upper ends to the lower ends further extend in opposite directions in a planar view as viewed from above. In other words, regarding the damper 10 holding the left ends of the shelf plates 240 the first base 20 is mounted on the top surface 1U at the rear surface 1B side of the furniture 1, whereas the second base 30 is mounted on the ceiling C at the front surface 1F side of the furniture 1 as compared with the first bases 20. On the other hand, regarding the damper 10 holding the right ends of the shelf plates 240, the first base 20 is mounted on the top surface 1U at the front surface 1F side of the furniture 1, whereas the second base 30 is mounted on the ceiling C at the rear surface 1B side of the furniture 1 as compared with the first base 20. The right and the left refer to those as viewed from the front surface 1F side of the furniture 1 with the vibration damping shelf being mounted between the furniture 1 and the ceiling C.

Since the first bases 20 and the second bases 30 are thus mounted, the locations where the shelf plates 240 are held on the holding parts 14 of the cylinder 10 at the left short sides of the shelf plates 240 differ from the locations where the shelf plates 240 are held on the holding parts 14 of the cylinder 10 at the right short sides of the shelf plates 240. In other words, regarding the upper shelf plate 240, a substantially middle part of the left short side in the front-back direction is held on the holding part 14, whereas a rear part of the right short side is held on the holding part 14. Regarding the lower shelf plate 240, a substantially middle part of the left short side in the front-back direction is held on the holding part 14, whereas a front part of the right short side is held on the holding part 14.

In the vibration damping shelf, the first abutment surfaces 21A of the respective first bases 20 are caused to be brought into face-to-face contact with the top surface 1U of the furniture 1 thereby to be placed thereon. Then, the second abutment surfaces 31A of the respective second bases 30 are caused to be brought into face-to-face contact with the ceiling C while the dampers 10 having been extended to the maximum by an expansion force of the compression gas enclosed in the respective cylinders 11 are being contracted, so that the vibration damping shelf is mounted on the top surface 1U of the furniture 1 and the ceiling C. Thus, both ends of each damper 10 of the vibration damping shelf can respectively be mounted on the top surface 1U of the furniture 1 and the ceiling C. Upon occurrence of quakes of earthquake or the like, the dampers 10 of the vibration damping shelf are contracted with the result that the quakes can be damped by the damping force of the dampers 10. In other words, the vibration damping shelf can suppress shake of the shelf plates 240 each having the right and left ends held by the dampers 10 and accordingly suppress fall of articles placed on the shelf plates 240, In the vibration damping shelf, the shelf plates 240 are held on the holding parts 14 provided on the cylinders 11. When quakes of earthquake or the like extend/contract the dampers 10, the rods 13 move forward and backward relative to the respective cylinders 11. Therefore, displacement of the cylinders 11 is small, and accordingly fluctuation of heightwise positions of the respective shelf plates 240 can be reduced. As a result, the vibration damping shelf can suppress fall of the articles placed on the shelf plates 240 due to quakes of earthquake or the like.

Furthermore, the furniture 1 to which the first bases 20 of the dampers 10 are mounted is subjected to a force from quakes of earthquake or the like. The force can be damped by the damping force of the dampers 10 with the result that shake of the furniture 1 can be suppressed. In more detail, when the furniture 1 is tilted to the front surface 1F side, the damper 10 holding the left ends of the shelf plates 240 is contracted to exert a damping force. Furthermore, when the furniture 1 is tilted to the rear surface 1B side, the damper 10 holding the right ends of the shelf plates 240 is contracted to exert a damping force. Thus, the vibration damping shelf can prevent the furniture 1 from overturn by damping the force to tilt the furniture 1 due to quakes of earthquake or the like.

Accordingly, the vibration damping shelf of the second embodiment can prevent the furniture 1. from overturn by suppressing shake of the furniture 1, while suppressing fall of the articles placed on the shelf plates 240.

### Third Embodiment

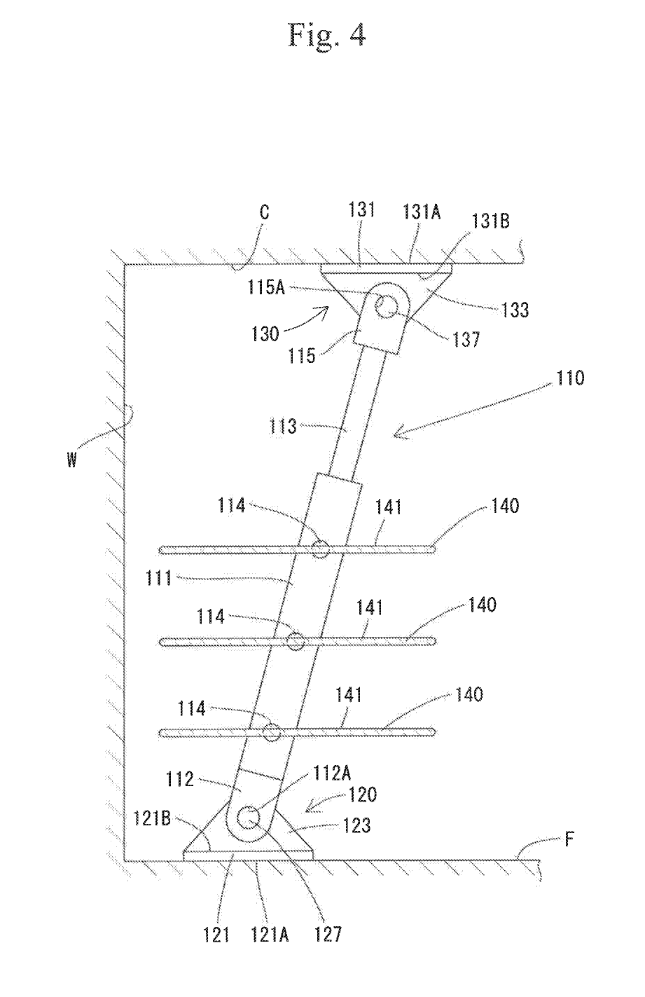

The vibration damping shelf of a third embodiment includes a pair of dampers 110 and three shelf plates 140 serving as the shelf members, as illustrated in FIG. 4. The third embodiment differs from the first and second embodiments in that the dampers 110 and the shelf plates 140 are larger than those of the first and second embodiments in size and that the dampers 110 have both ends respectively mounted on a floor surface F and the ceiling C. In the third embodiment, the identical or similar parts are labeled by the same reference symbols as those in the first and second embodiments and detailed description of such parts will be eliminated.

In the vibration damping shelf, three holding parts 114 are provided on the outer peripheral surface of each cylinder 111 to hold the shelf plates 140. The holding parts 114 are located on a straight line parallel to the axis line of each cylinder 111 at regular intervals. The first base 120 of each damper 110 is mounted on the floor surface F, and the second base 130 of each damper 110 is mounted on the ceiling C while the axis line of each damper 110 is inclined at a predetermined angle. In other words, the location of the first base 120 mounted on the floor surface F is spaced from the location of the second base 130 mounted on the ceiling C, so that the axis lines of the respective dampers 110 extending from the upper ends to the lower ends are downwardly inclined in parallel with each other. In this state, the holding parts 140 are configured to hold the shelf plates 140 so that upper surfaces 141 of the shelf plates 140 are horizontally spread.

Each first base 120 has the first base plate 121 and the first connecting part 123. The first base plate 121 has a flat plate shape and includes a first abutment surface 121A brought into face-to-face contact with the floor surface F. The first abutment surface 121A is rectangular in shape. The first connecting part 123 has a flat plate shape and upwardly protrudes continuously from a surface 121B of the first base plate 121 (a surface located at the side opposed to the first abutment surface 121A) with the first base 120 having been mounted on the floor surface F. In more detail, the first connecting part 123 longitudinally extends in a middle part of the first base plate 121 with respect to the short side direction and, with the first base 120 having been mounted on the floor surface F, the first connecting part 23 has upper surfaces which are inclined so as to ascend from both longitudinal ends toward a middle part thereof. The first connecting part 123 has a first shaft 127 which is columnar in shape and extends from both side surfaces of the longitudinal middle part of the first connecting part 123 on the identical straight line perpendicular to the side surfaces. The cylinder 111 has a pair of cylinder side connecting parts 112 formed with respective through holes 112A into which the ends of the first shaft 127 extending from both side surfaces of the first connecting part 123 are inserted in a retained state, so that the cylinder 111 is connected to the first base 120 so as to be rotatable about the first shaft 127.

Each second base 130 has the second base plate 131 and the second connecting part 133. The second base plate 131 has a flat plate shape and includes a second abutment surface 131A brought into face-to-face contact with the ceiling C. The second abutment surface 131A is rectangular in shape. The second connecting part 133 has a flat plate shape and downwardly protrudes continuously from a surface 131B of the second base plate 131 (a surface located at the side opposed to the second abutment surface 131A) with the second base 130 having been mounted on the ceiling C. In more detail, the second connecting part 133 longitudinally extends in a middle part of the second base plate 131 with respect to the short side direction and, with the second base 130 having been mounted on the ceiling C, the second base plate 131 has lower surfaces which are inclined so as to descend from both longitudinal ends toward a middle part thereof. The second connecting part 133 has a second shaft 137 which is columnar in shape and extends from both side surfaces of the longitudinal middle part of the second connecting part 133 on the identical straight line perpendicular to the side surfaces. The rod 113 has a pair of rod side connecting parts 115 formed with respective through holes 115A into which the ends of the second shaft 137 extending from both side surfaces of the second connecting part 133 are inserted in a retained state, so that the rod 113 is connected to the second base 130 so as to be rotatable about the second shafts 137.

Each shelf plate 140 is flat plate-shaped and has a rectangular shape long in the right-left direction. Each shelf plate 140 includes short sides which serve as a right and left ends and are each held on the holding part 114 provided on the cylinder 111 of each damper 110. As described above, when the first bases 120 are mounted on the floor surface F and the second bases 130 are mounted on the ceiling C so that the axis lines of the dampers 110 extend in parallel with each other while being inclined at a predetermined angle, the shelf plates 140 are held at regular intervals in the up-down direction with the upper surfaces 141 being spread in the horizontal direction.

In the vibration damping shelf, the first abutment surfaces 121A of the respective first bases 120 are caused to be brought into face-to-face contact with the floor surface F thereby to be placed thereon. Then, the second abutment surfaces 131A of the respective second bases 30 are caused to be brought into face-to-face contact with the ceiling C while the dampers 110 having been extended to the maximum by an expansion force of the compression gas enclosed in the respective cylinders 111 are being contracted, so that the vibration damping shelf is mounted on the floor surface F and the ceiling C. Thus, both ends of each damper 110 of the vibration damping shelf can respectively be mounted on the floor surface F and the ceiling C. Upon occurrence of quakes of earthquake or the like, the dampers 110 of the vibration damping shelf are contracted with the result that the quakes can be damped by the damping force of the dampers 110. In other words, the vibration damping shelf can suppress shake of the shelf plates 140 each having the right and left ends held by the dampers 110 and accordingly suppress fall of articles placed on the shelf plates 140. In the vibration damping shelf, the shelf plates 140 are held on the holding parts 114 provided on the cylinders 111. When quakes of earthquake or the like extend/contract the dampers 110, the rods 113 move forward and backward relative to the respective cylinders 111. Therefore, displacement of the cylinders 111 is small, and accordingly fluctuation of heightwise positions of the respective shelf plates 140 can be reduced. As a result, the vibration damping shelf can suppress fall of the articles placed on the shelf plates 140 due to quakes of earthquake or the like.

Furthermore, the room having the floor surface F and the ceiling C to both of which the dampers 110 are mounted is subjected to a force from quakes of earthquake or the like. The force can be damped by the damping force of the dampers 110 with the result that shake of the room can be suppressed.

Accordingly, the vibration damping shelf of the third embodiment can suppress shake of the room, while suppressing fall of the articles placed on the shelf plates 140.

### Fourth Embodiment

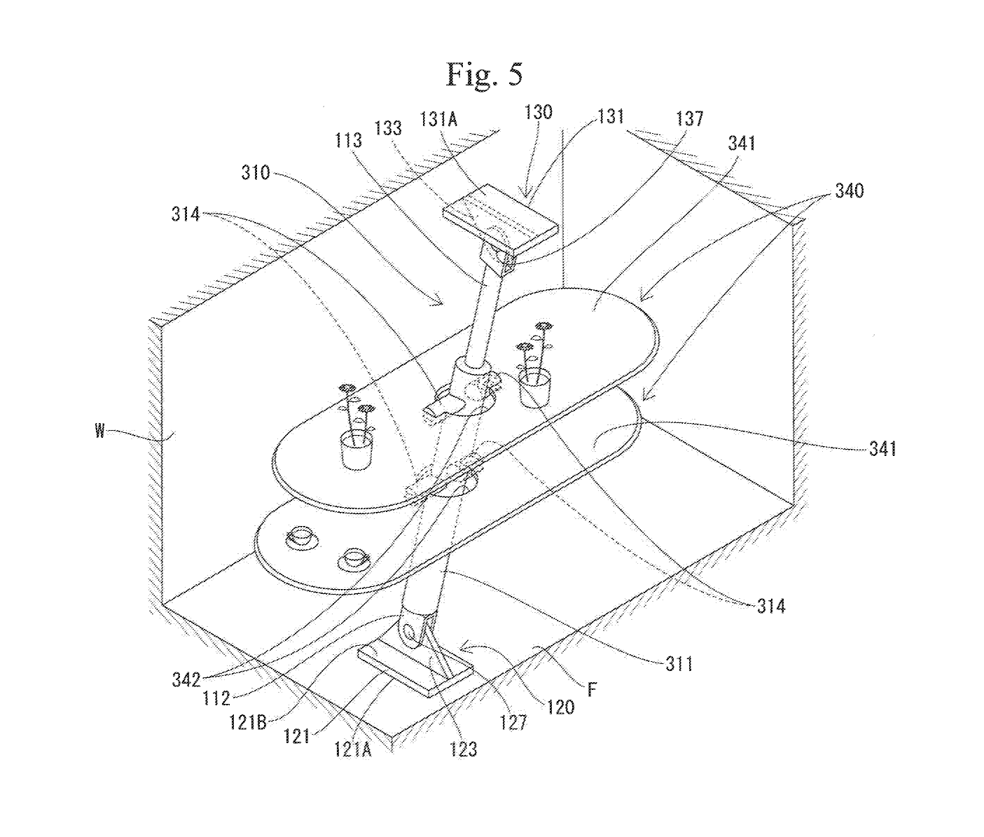

The vibration damping shelf of a fourth embodiment differs from that of the third embodiment in that two shelf plates 340 serving as shelf members are held on a single damper 310, as illustrated in FIG. 5. In the fourth embodiment, the identical or similar parts are labeled by the same reference symbols as those in the third embodiment and detailed description of such parts will be eliminated.

The vibration damping shelf is provided with two pairs of holding parts 314 extending from two locations on an outer peripheral surface of the cylinder 311 in the right-left direction on respective identical outer circumferences, which locations are spaced from each other along the axis line of the cylinder 311 of the damper 310. Each shelf plate 340 has a flat plate shape long in the right-left direction. Each shelf plate 340 has right and left ends each of which is formed into an arc shape. Each shelf plate 340 has a circular through hole 342 formed through a central part thereof and having an inner diameter larger than the outer diameter of the cylinder 311 of the damper 310. Each shelf plate 340 is nipped by the holding parts 314 of the cylinder 311 from the inner peripheral edge of the through hole 342 thereby being held with the cylinder 311 having been inserted through the through holes 342. The first base 120 of the damper 310 is mounted on the floor surface F and the second base 130 of the damper 310 is mounted on the ceiling (not illustrated) with the axis line of the damper 310 being inclined at a predetermined angle. In other words, the position of the first base 120 mounted on the floor surface F is horizontally spaced from the position of the second base 130 mounted on the ceiling, with the result that the axis line of the damper 310 extending from the upper end to the lower end is downwardly inclined. In this state, the holding parts 314 are configured to hold the shelf plates 340 so that the upper surfaces 341 of the shelf plates 340 are horizontally spread.

In the vibration damping shelf, the first abutment surface 121A of the first base 120 is caused to be brought into face-to-face contact with the floor surface F thereby to be placed thereon. Then, the second abutment surface 131A of the second. base 130 is caused to be brought into face-to-face contact with the ceiling while the damper 310 having been extended to the maximum by an expansion force of the compression gas enclosed in the cylinder 311 is being contracted, so that the vibration damping shelf is mounted on the floor surface F and the ceiling. Thus, both ends of the damper 310 of the vibration damping shelf can be respectively mounted on the floor surface F and the ceiling. Upon occurrence of quakes of earthquake or the like, the damper 310 of the vibration damping shelf is contracted with the result that the quakes can be damped by the damping force of the damper 310. In other words, the vibration damping shelf can suppress shake of the shelf plates 340 held by the damper 310 and accordingly suppress fall of articles placed on the shelf plates 340. The shelf plates 340 are held on the holding parts 314 provided on the cylinder 311 of the vibration damping shelf. When quakes of earthquake or the like extend/contract the damper 310, the rod 113 moves forward and backward relative to the cylinder 311. Therefore, displacement of the cylinder 311 is small, and accordingly fluctuation of heightwise positions of the shelf plates 340 can be reduced. As a result, the vibration damping shelf can suppress fall of articles placed on the shelf plates 340 due to quakes of earthquake or the like.

Furthermore, the room having the floor surface F and the ceiling to both of which the damper 310 is mounted is subjected to a force from quakes of earthquake or the like. The force is damped by the damping force of the damper 310 with the result that shake of the room can be suppressed.

Accordingly, the vibration damping shelf of the fourth embodiment can suppress shake of the room, while suppressing fall of the articles placed on the shelf plates 340.

### Fifth Embodiment

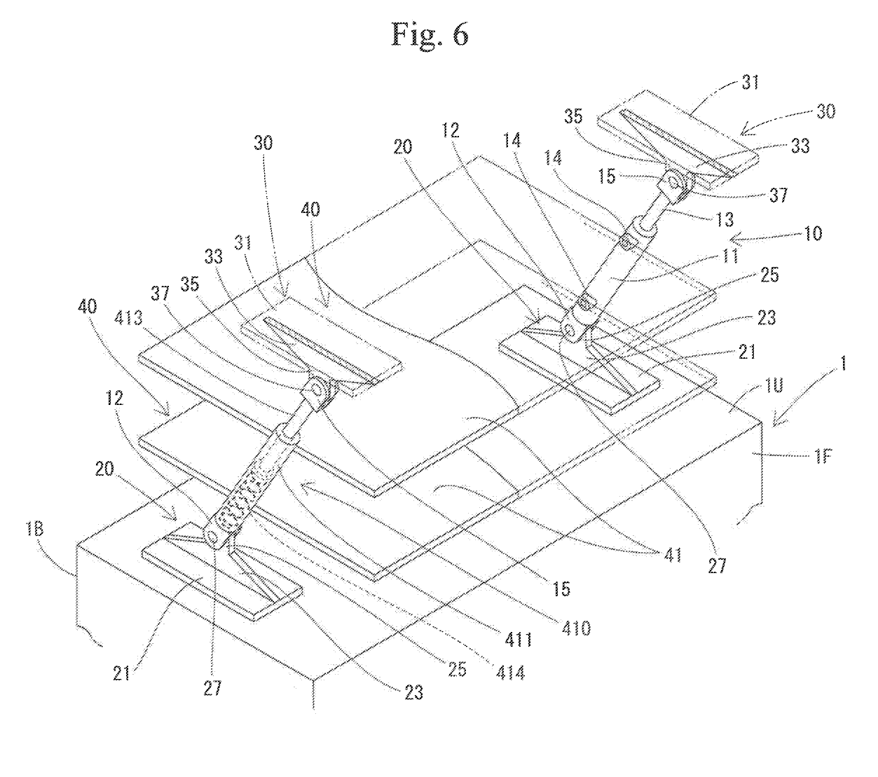

The vibration damping shelf of a fifth embodiment includes a single damper 10 having an identical structure with that in the first embodiment and a single biasing member 410, as illustrated in FIG. 6. The biasing member 410 includes a cylinder 411 and a rod 413 protruding upward from the cylinder 411. A compression coil spring 414 is housed in a space below the rod 413 in the cylinder 411. The compression coil spring 414 biases the rod 413 in an extension direction. The compression coil spring 414 is mounted on identical counterpart members with those of the damper 10 (the top surface 1U of the furniture 1 and the ceiling C) via the cylinder 414, the rod 413, the first base 20, and the second base 30. Upon contraction of the biasing member 410, the compression coil spring 414 imparts an extension force to the rod 413. In the fifth embodiment, the identical or similar parts are labeled by the same reference symbols as those in the first embodiment and detailed description of such parts will be eliminated.

The present invention should not be limited to the first to fifth embodiments described above with reference to the drawings, but the technical scope of the invention encompasses the following embodiments, for example.

(1) Although the flat plate-shaped shelf members are used in the first to fifth embodiments, another shape of shelf members may be used.
(2) Although two or three shelf plates are provided in the first to fifth embodiments, one, four or more shelf plates may be provided.
(3) Although both ends of the damper are respectively mounted on the top surface of the furniture and the ceiling in the first, second, and fifth embodiments, both ends of the damper may respectively be mounted on the top surface of the furniture and the wall surface.
(4) Although both ends of the damper are respectively mounted on the floor surface and the ceiling in the third and fourth embodiments, both ends of the damper may respectively be mounted on the wall surface and the ceiling, or on the floor surface and the wall surface.
(5) Although the dampers are compression dampers in the first to fifth embodiments, the damper may be a two-way damper or an extension damper.
(6) Although the shelf plates are supported on the cylinder/cylinders in the first to fifth embodiments, the shelf plates may be supported on the rod/rods.
(7) Although both ends of the damper are mounted on the top surface of the furniture and the ceiling or on the floor surface and the ceiling, with the axis line of the damper being inclined at the predetermined angle in the first to fifth embodiments, both ends of the damper may respectively be mounted on the top surface of the furniture and the ceiling or on the floor surface and the ceiling with the axis line of the damper extending in the vertical direction.
(8) The structure of adding the biasing member provided with the compression coil spring in the fifth embodiment may also be applied to the second to fourth embodiments. In the fourth embodiment in which only one damper is used, if the biasing member provided with the compression coil, spring is added between the members to which the damper is mounted, this can improve the vibration damping function at lower costs than the case where one more damper is further added.

### EXPLANATION OF REFERENCE SYMBOLS

10, 110, 310 . . . damper, 11, 111, 311 . . . cylinder, 13, 113 . . . rod, 40, 140, 240, 340 . . . shelf plate (shelf member), 410 . . . biasing member, 414 . . . compression coil spring, 1 . . . furniture (article), 1U . . . top surface of (the furniture), C . . . ceiling, W . . . wall surface, F . . . floor surface (installation surface).

1. A vibration damping shelf comprising:
a damper having two ends mounted on respective positions spaced from each other in an up-down direction; and
a shelf member held on the damper.

2. The vibration damping shelf according to claim 1, wherein the shelf member has a right end and a left end both of which are respectively held on a pair of the dampers.

3. The vibration damping shelf according to claim 2, wherein the paired dampers have respective axis lines extending from upper ends to lower ends of the dampers, the axis lines being inclined with the ends of the dampers being mounted on the positions spaced from each other in the up-down direction.

4. The vibration damping shelf according to claim 3, wherein the axis lines of the paired dampers have respective directions of inclination opposed to each other as the dampers are viewed sideways.

5. The vibration damping shelf according to claim 1, wherein the ends of the damper/dampers are respectively mounted on an installation surface and a ceiling, or the installation surface and a wall surface extending vertically from the installation surface, or the wall surface and the ceiling, or a top surface of an article installed on the installation surface and he ceiling, or the top surface of the article and the wall surface.

6. The vibration damping shelf according to claim 1, wherein:
the damper or each of the dampers includes a cylinder which is bottomed and is cylindrical in shape, piston slidably inserted into the cylinder, a rod guide closing an opening of the cylinder, and a rod having a proximal end connected to the piston and a distal end side which is inserted through the rod guide and protrudes out of the cylinder; and
the shelf member is held on the cylinder.

7. The vibration damping shelf according to claim 1, further comprising a compression spring having an upper end and a lower end both of which are each mounted on an identical counterpart member with that of the damper.

8. The vibration damping shelf according to claim 2, wherein the ends of the damper/dampers are respectively mounted on an installation surface and a ceiling, or the installation surface and a wall surface extending vertically from the installation surface, or the wall surface and the ceiling, or a top surface of an article installed the installation surface and the ceiling, or the top surface of the article and the wall surface.

9. The vibration damping shelf according to claim 3, wherein the ends of the damper/dampers are respectively mounted on an installation surface and a ceiling, or the installation surface and a wall surface extending vertically from the installation surface, or the wall surface and the ceiling, or a top surface of an article installed on the installation surface and the ceiling, or the top surface of the article and the wall surface.

10. The vibration damping shelf according to claim 4, wherein the ends of the damper/dampers are respectively mounted on an installation surface and a ceiling, or the installation surface and a wall surface extending vertically from the installation surface, or the wall surface and the ceiling, or a top surface of an article installed on the installation surface and the ceiling, or the top surface of the article and the wall surface.

11. The vibration clamping shelf according to claim 2, wherein:
the damper or each of the dampers includes a cylinder which is bottomed and is cylindrical in shape, a piston slidably inserted into the cylinder, a rod guide closing an opening of the cylinder, and a rod having a proximal end connected to the piston and a distal end side which is inserted through the rod guide and protrudes out of the cylinder; and
the shelf member is held on the cylinder.

12. The vibration damping shelf according to claim 3, wherein:
the damper or each of the dampers includes a cylinder which bottomed and is cylindrical in shape, a piston, slid ably inserted into the cylinder, a rod guide closing an opening of the cylinder, and a rod having a proximal end connected to the piston and a distal end side which is inserted through the rod guide and protrudes out of the cylinder; and
the shelf member is held on the cylinder.

13. The vibration clamping shelf according to claim 4, wherein:
the damper or each of the dampers includes a cylinder which is bottomed and is cylindrical in shape, a piston slidably inserted into the cylinder, a rod guide closing an opening of the cylinder, and a rod having a proximal end connected to the piston and a distal end side which, is inserted through the rod guide and protrudes out of the cylinder; and
the shelf member is held on the cylinder.

14. The vibration damping shelf according to claim 2, further comprising a compression spring having an upper end and a lower end both of which are each mounted on an identical counterpart member with that of the damper.

15. The vibration damping shelf according to claim 3, further comprising a compression spring having an upper end and a lower end both of which are each mounted on an identical counterpart member with that of the damper.

16. The vibration damping shelf according to claim 4, further comprising a compression spring having an upper end and a lower end both of which are each mounted on an identical counterpart member with that of the damper.
